(19) United States
(12) Patent Application Publication
(10) Pub. No.: US 2008/0246972 A1
(43) Pub. Date: Oct. 9, 2008

(54) Tomographic Imaging by an Interferometric Immersion Microscope

(76) Inventors: Arnaud Dubois, Antony (FR); Albert-Claude Boccara, Paris (FR)

Correspondence Address: BLANK ROME LLP, 600 NEW HAMPSHIRE AVENUE, N.W., WASHINGTON, DC, 20037, US

(21) Appl. No.: 11/997,929

(22) PCT Filed: Aug. 4, 2006
(86) PCT No.: PCT/FR2006/001909

§ 371 Date: May 27, 2008

(30) Foreign Application Priority Data
Aug. 8, 2005 (FR) 0508428

(51) Int. Cl. G01B 9/02

(52) U.S. Cl. 356/521

(57) ABSTRACT

A device for the tomographic imaging of an object to be analyzed, the device comprising a light source that emits a light beam with a coherence length substantially equal to the thickness of a slice of the object to be analyzed; and an interferometric imaging system comprising at least one objective, a reference mirror and a light-beam splitting means; wherein the interferometric system is arranged so that the objective defines a first focusing plane at the slice of the object to be analyzed and a second focusing plane at the reference mirror, and wherein the interferometric imaging system comprises at least a first compensating medium positioned between the second focusing plane and the splitting means, the thickness and the optical index of the at least one compensating medium having optical properties such that a first optical path of the light beam emitted from the light source between the first focusing plane and the splitting means is substantially equal to a second optical path of the light beam between the second focusing plane and the splitting means and such that a first dispersion between the first focusing plane and the splitting means is substantially equal to a second dispersion of the light beam between the second focusing plane and the splitting means.

### CROSS-REFERENCE TO RELATED APPLICATIONS

This application is a National Phase Application of PCT/FR2006/01909, filed on Aug. 4, 2006, which claims priority to French Application No. FR 05/08428, filed on Aug. 8, 2005, which are hereby incorporated by reference.

### FIELD OF THE INVENTION

The present invention relates to the field of interferometry. More particularly, the present invention relates to an interferometry imaging device, specially adapted to perform tomographic imaging.

### BACKGROUND OF THE INVENTION

Already known in the prior art are interferometry tomographic imaging devices comprising an interferometry device of, for example, the Mirau, Michelson or Linnik type in which the light source has a low coherence length making it possible to locate the interference fringes in a localized region based on the coherence length. Examples of these prior art devices are illustrated, for example, in FIGS. 1A, 1B and 1C.

However, in such devices, a dispersion is observed between the two arms of the interferometer because one of the arms enters the object to be imaged (hereinafter “the object arm”) and the other does not (hereinafter “the reference arm”). There is also observed, at the object to be analyzed, an offset between the focusing plane of the objective and a plane corresponding to a zero optical path length difference in the interferometer. Moreover, if a known immersion objective is used as illustrated in FIG. 2, the travel of the light in the immersion medium causes an accentuation of the phenomena mentioned above.

The use of an immersion objective is disclosed, for example, in the U.S. Patent Application Publication No. 2005/0088663 to De Groot et al. (hereinafter “De Groot”). This document discloses a method of analyzing a signal supplied by a white-light interferometric microscope for studying structures under the surface of an object. In one embodiment of an interferometric microscope disclosed in this document, the microscope may be an immersion microscope.

De Groot, however, does not disclose how to prevent, at the object to be imaged, a shift between the focusing plane of the objective and the plane corresponding to a zero optical path length difference in the interferometer. To the contrary, it is noted that the effect of differences in chromatic dispersion between the two arms of the interferometer are taken into account in the analysis of the signals supplied by the interferometric microscope, which means that these effects are not compensated for by the microscope of De Groot.

European Application No. EP0503236 to Batchelder et al. (hereinafter “Batchelder”) discloses an appliance for performing high-resolution imaging in the near infrared of the internal structure of a semiconductor wafer. This device comprises an optical device positioned close to the wafer. This optical device may comprise a piano-convex lens. The plano-convex lens can be separated from the wafer by an optical coupling fluid to enable the wafer to be moved under the lens. One of the embodiments of Batchelder teaches that the piano-convex lens can be used in a Linnik interferometer. The fluid disclosed by Batchelder, however, does not compensate for the differences between the two arms of the interferometer and, in particular, dispersion and/or optical path length difference.

One of the aims of the present invention is to reduce the dispersion between the two arms of the interferometer in the case of tomographic imaging and to make best coincide, at the object to be imaged, the focussing plane and the plane corresponding to a zero running difference. Another aim of the present invention is also to allow better penetration of the light into the object to be imaged.

### SUMMARY OF THE INVENTION

Accordingly, to solve at least the above problems and/or disadvantages and to provide at least the advantages described below, a non-limiting object of the present invention is to provide a device for the tomographic imaging of an object to be analyzed, the device comprising a light source that emits a light beam with a coherence length substantially equal to the thickness of a slice of the object to be analyzed; and an interferometric imaging system comprising at least one objective, a reference mirror and a light-beam splitting means; wherein the interferometric system is arranged so that the objective defines a first focusing plane at the slice of the object to be analyzed and a second focusing plane at the reference mirror; and wherein the interferometric imaging system comprises at least a first compensating medium positioned between the second focusing plane and the splitting means, the thickness and the optical index of the at least one compensating medium having optical properties such that a first optical path of the light beam emitted from the light source between the first focusing plane and the splitting means is substantially equal to a second optical path of the light beam between the second focusing plane and the splitting means, and such that a first dispersion between the first focusing plane and the splitting means is substantially equal to a second dispersion of the light beam between the second focusing plane and the splitting means.

Preferably, the interferometric imaging system also comprises at least a third medium with an optical index and thickness chosen so that the first optical path is substantially equal to the second optical path so that the first dispersion is substantially equal to the second dispersion.

In order to maintain equality of the first and second dispersion and first and second optical path regardless of the location of the focusing plane at the object to be analyzed, the interferometric imaging system also comprises at least a second medium positioned between the first focussing plane and the splitting means, the second medium having optical properties substantially equal to the optical properties of the said object to be analyzed. The first medium may possess optical properties substantially equal to the optical properties of the object to be analyzed. The device is particularly suitable when the object to be analyzed is essentially composed of water.

The present invention also concerns an interferometer intended for the tomographic imaging of a slice of an object to be analyzed, the interferometer comprising a means of fixing to an objective, a reference mirror and a light beam splitting means; wherein the interferometer is arranged so that the objective defines a first focusing plane at the slice of the object to be analyzed and a second focusing plane at a surface of the reference mirror; and wherein the interferometer comprises at least a first compensating medium positioned between the second focusing plane and the splitting means, the thickness and optical index of the compensating medium being such that a first optical path of a light beam between the first focusing plane and the splitting means is substantially equal to a second optical path of the light beam between the second focusing plane and the splitting means so that a first dispersion between the first focusing plane and the splitting means is substantially equal to a second dispersion of the light beam between the second focusing plane and the splitting means.

In order to maintain equality of the first and second dispersion and first and second optical path regardless of the location of the focusing plane at the object to be analyzed, the interferometric imaging system may also comprise at least a second medium positioned between the first focusing plane and the splitting means, the at least one second medium having optical properties substantially equal to the optical properties of the object to be analyzed.

Advantageously, the fixing means may allow adjustment of the interferometer on the objective, for example on a standard immersion objective.

Preferably, the interferometric imaging system also comprises at least a third medium with an optical index and thickness chosen so that the first optical path is substantially equal to the second optical path and the first dispersion is substantially equal to the second dispersion.

These and other objects of the invention, as well as many of the intended advantages thereof, will become more readily apparent when reference is made to the following description, taken in conjunction with the accompanying drawings.

### BRIEF DESCRIPTION OF THE FIGURES

The invention will be understood better with the help of the description, given below for purely explanatory purposes, of an embodiment of the invention, with reference to the accompanying figures:

FIGS. 1A, 1B and 1C illustrate interferometric devices according to the prior art;

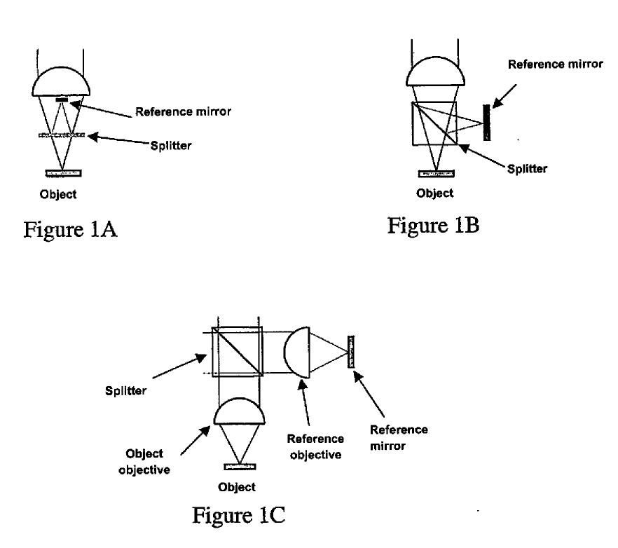

FIG. 2 illustrates a known immersion objective according to the prior art;

FIG. 3 illustrates an embodiment of the invention;

FIG. 4 illustrates an embodiment of the present invention in which an interferometric device is positioned on an immersion objective;

FIG. 5 illustrates a schematic view of the compensating media according to the present invention at the reference arm and the object arm of the interferometer;

FIGS. 6A and 6B illustrate a schematic view of the compensating media according to the present invention at the reference arm and the object arm of the interferometer when the focusing plane is positioned at different locations within the object to be analyzed.

### DETAILED DESCRIPTION OF EXEMPLARY EMBODIMENTS

Reference will now be made in detail to non-limiting embodiments of the present invention by way of reference to the accompanying drawings, wherein like reference numerals refer to like parts, components and structures.

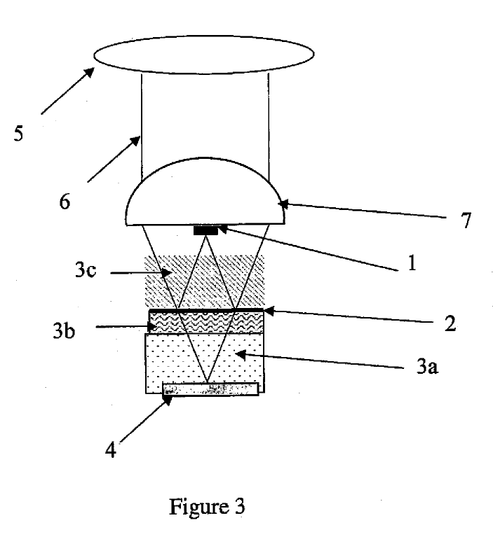

The invention comprises an interferometric microscope. Illustrated in FIG. 3, an objective of the Mirau type is shown, but it must be understood that the invention is also adaptable to any type of known interferometric objective, for example of the Linnik or Michelson type.

As illustrated in the exemplary embodiment of FIG. 3, a source 5 produces a light signal carried by a beam 6. In a manner known per se for tomographic imaging, the light source 5 has a broad spectrum and, therefore, a small coherence length in order to observe interference fringes for optical path length differences comparable to the coherence length. This makes it possible to observe fine slices of an object to be analyzed 4 and, therefore, to obtain a good axial resolution. The coherence length of the source is typically around one micrometer or a few micrometers and the source is, for example, a filament lamp, a xenon or mercury arc lamp, or a light emitting diode (LED).

The reference mirror 1 of the interferometric system according to the present invention preferably has a reflection coefficient comparable to the global reflectivity of the object to be analyzed 4 in order to minimize the difference in amplitude of the signal issuing from the mirror and the signal issuing from the object to be analyzed 4. The signal to noise ratio of the interferences observed is in this way optimized. In particular, for the observation of living cells essentially composed of water, a mirror with a coefficient of reflection of around 1% or a few percent is chosen.

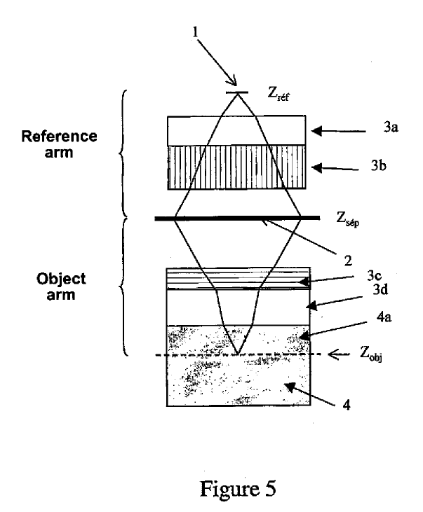

In the interferometer according to the present invention, there are defined firstly the reference arm formed by the zone between the reference mirror 1 and the splitter plane 2, and the object arm formed by the zone between the splitter 2 and the focusing plane in the object to be analyzed 4, as illustrated in FIG. 5.

The position of the focusing plane of the objective 7 in the object arm is defined as Z_{obj}. This plane is situated in the object to be analyzed 4. Z_{ref} is the position of the focusing plane of the objective 7 in the reference arm. This plane is situated on the surface of the reference mirror 1.

The compensating medium or media 3a, 3b, 3c and 3d is or are arranged so that the optical paths in the two arms are identical and the two arms have substantially the same dispersion. Denoting the position of the splitter 2 as Zₛₑₚ, the optical path from Z_{ref} to Zₛₑₚ must therefore be substantially equal to the optical path from Zₛₑₚ to Z_{obj}.

In the exemplary embodiment, (Z_{ref})ⱼ and (n_{ref})ⱼ are respectively the thicknesses and optical indices of the compensating media in the reference arm and (Z_{obj})ᵢ and (n_{obj})ᵢ are respectively the thicknesses and optical indices of the compensating media in the object arm. The condition of equality of the optical path is represented as follows:

$${\sum }_{i} {( {n}_{obj} )}_{i} \times {( {z}_{obj} )}_{i} = {\sum }_{j} {( {n}_{ref} )}_{j} \times {( {z}_{ref} )}_{j} \qquad Equation ( 1 )$$

The condition of equality of the dispersion in the two arms is written approximately as follows:

$${\sum }_{i} \frac{d {( {n}_{obj} )}_{i}}{d λ} \times {( {z}_{obj} )}_{i} = {\sum }_{j} \frac{d {( {n}_{ref} )}_{j}}{d λ} \times {( {z}_{ref} )}_{j} \qquad Equation ( 2 )$$

The condition of formation of the images in the object and on the reference mirror is written, under Gauss conditions, as follows:

$${\sum }_{i} \frac{{( {Z}_{obj} )}_{i}}{{( {n}_{obj} )}_{i}} = {\sum }_{j} \frac{{( {Z}_{ref} )}_{j}}{{( {n}_{ref} )}_{j}} \qquad Equation ( 3 )$$

Other more complex equations can also be used to represent the conditions of equality of optical paths, dispersion and focusing. These equations are known to persons skilled in the art in the field of light propagation. These more precise equations can be used in order to obtain more refined solutions, and it should be understood that Equations (1), (2) and (3) are given here only by way of non-limitative examples.

As illustrated in FIG. 5, the optical indices and the thicknesses of the media 3a, 3b, 3c and 3d are chosen so as to compensate for the dispersion and difference in optical path introduced by the passage of the light beam 6 through the object to be analyzed 4 at the object arm in the part 4a. These media are then chosen so as to satisfy Equations (1), (2) and (3). At least one of these compensating media is positioned in the reference arm so as to compensate for dispersion due to the passage of the light beam 6 through part 4a of the object to be analyzed 4.

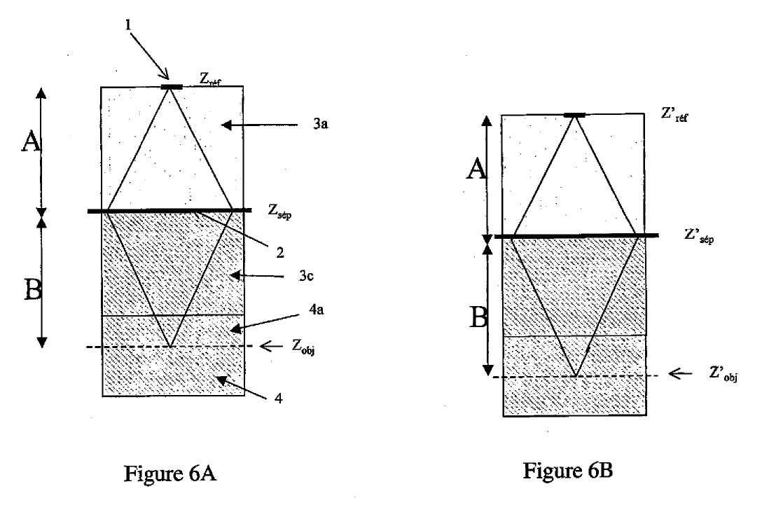

In addition, as illustrated in FIGS. 6a and 6b, when it is desired to observe the object to be analyzed 4 at a different location or depth, the focusing plane Z_{obj} may be moved to a different thickness in the object to be analyzed 4 so as to define a focusing plane Z′_{obj}, at a different location in the object arm. It is advantageous to maintain the equality of the dispersions and optical paths in the two arms following this movement.

According to an embodiment of the present invention not shown, it is possible to use at least one compensating medium that can vary in thickness when the objective 7 moves and when the focusing plane Z_{obj} is relocated in order to maintain the equality of the dispersions and optical paths in the two arms. In this case, the medium is not necessarily placed in contact with the object to be analyzed 4 and the media chosen can have optical characteristics different from those of the object to be analyzed 4.

According the exemplary embodiment illustrated in FIGS. 6a and 6b, a first medium 3c whose optical characteristics are substantially identical to those of the object to be analyzed 4 is positioned in the object arm and in contact with the object to be analyzed 4. For example, if the object to be analyzed 4 is a biological object, water or another liquid whose optical properties are close to water, such as PBS (Phosphate Buffer Saline), will preferably be chosen. This medium comprising the object to be analyzed 4 and to the medium 3c positioned in the object arm will hereinafter be termed “medium M”. In this way, when focusing is carried out at a new location (change from FIG. 6a to FIG. 6b), the optical path and the dispersion between the splitter 2 and the focusing plane Z′_{obj}. is scarcely changed. It is therefore possible to compensate for the thickness B being passed through by a medium of fixed thickness 3a positioned in the reference arm, no matter what location at which the focusing plane Z_{obj}. or Z′_{obj}. is located in the object to be analyzed 4.

The medium 3a in the reference arm can, for example, simply be the same as the medium M, or any other compensating medium of fixed thickness, making it possible to maintain the equality of the dispersions and optical paths between the object arm and the reference arm. Other compensating media can also be added to the two arms of the interferometer.

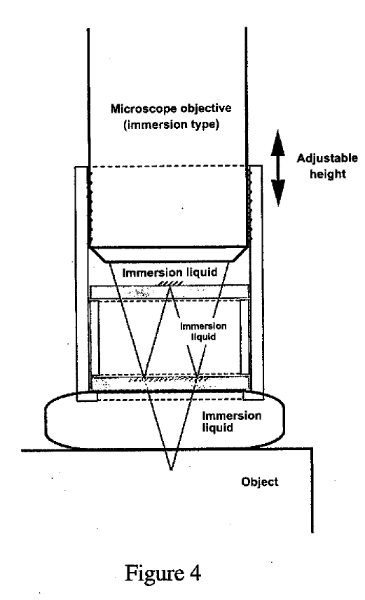

According to an embodiment of the invention particularly adapted for the tomographic imaging of living cells, the two arms are immersed in water or a liquid with optical characteristics close to those of water as in FIG. 4. This is because living cells mainly consist of water and the two arms are immersed in water such that Equations (1), (2) and (3) are satisfied. The imaging of the living cells can thereby be carried out in a satisfactory manner.

According to other variants of the present invention and the object to be analyzed 4, the compensating medium can also be a gel or any other material satisfying the conditions of Equations (1), (2) and (3). It should be understood, however, that it is also possible to use another liquid in place of water having optical characteristics close to water, such as for example PBS (Phosphate Buffer Saline).

Equations (1), (2) and (3) can be resolved by an adapted program on computer-implemented software, with the possibility of adding other constraints such as the reduction of optical aberrations. Other equations associated with the dispersion, optical path and focusing constraints may also be resolved by software for precisely calculating the propagation of the rays, the optical paths, the dispersion and the aberrations, thus allowing optimizations.

According to the present invention, use is possibly made of special objectives designed to minimize the aberrations introduced by the media placed in the two arms of the interferometer. In the case where water (or a medium having optical characteristics close to water) is placed in the two arms of the interferometer, it suffices to use a water immersion objective such as those known from the prior art.

A person skilled in the art is able to easily determine the indices and thicknesses of the materials to be used, as well as the position of the reference mirror 1, so as to satisfy these conditions. The number of distinct media can also be variable and chosen by a person skilled in the art. These compensating media may be liquid, gels or special glasses.

The interference images are recorded by a matrix detector (not shown), for example of the CCD or CMOS camera type, and several out-of-phase interference images are recorded by the movement of a component of the interferometer, for example the reference mirror 1, or the whole of the interferometer. In the latter case, the interferometer according to the present invention is fixed, for example screwed, to a microscope objective at a variable height.

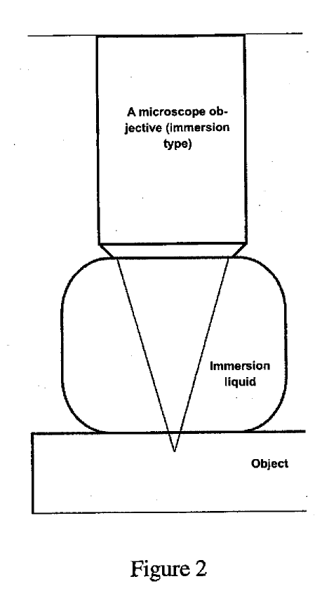

The present invention is particularly advantageous since standard immersion objectives exist commonly. Such standard immersion objectives are illustrated, for example, in FIG. 2. The function of the immersion medium used for these objectives is to avoid reflections on the surface of the object as well as to increase the resolution of the objective.

An interferometer comprising a reference mirror 1, a splitter 2 and one or more compensating media 3a, 3b, 3c and/or 3d are then fixed to the objective 7 so as to satisfy the conditions of equations (1), (2) and (3) as described previously. A compensating medium 3a, 3b, 3c or 3d is then positioned in the reference arm of the interferometer. If the objective 7 is of the water immersion type and the object to be analyzed 4 consists essentially of water, the compensating media 3a, 3b, 3c and/or 3d of the interferometer are preferably water or a medium having optical characteristics close to those of water. In this way, the paths traveled by the light beam 6 between the splitter 2 and the reference mirror 1 and between the splitter 2 and the focusing plane Z_{obj}. of the object to be analyzed 4 take place in almost identical media.

The combination of out-of-phase interferometric images then makes it possible to calculate the interferometric signal, which results in a tomographic image. Preferably, after acquisition of a stack of tomographic images, it is possible to reconstruct the object to be analyzed 4 in a three-dimensional fashion.

A person skilled in the art will easily understand that the present invention has been described and illustrated in an exemplary embodiment of an interferometer of the Mirau type, but that any type of interferometer can be used. In particular, in the case of a Michelson interferometer, the two arms of the interferometer form an angle of 90° instead of being along the same axis as in the case of the Mirau type interferometer. The present invention is particularly suited to optical coherence tomographic imaging (“Optical Coherence Tomography” or “OCT” in English).

1. A device for the tomographic imaging of an object to be analyzed, the device comprising:
a light source that emits a light beam with a coherence length substantially equal to the thickness of a slice of the object to be analyzed; and
an interferometric imaging system comprising:
at least one objective,
a reference mirror; and
a light-beam splitting means,
wherein the interferometric system is arranged so that the objective defines a first focusing plane at the slice of the object to be analyzed and a second focusing plane at the reference mirror, and
wherein the interferometric imaging system comprises at least a first compensating medium positioned between the second focusing plane and the splitting means, the thickness and the optical index of the at least one compensating medium having optical properties such that a first optical path of the light beam emitted from the light source between the first focusing plane and the splitting means is substantially equal to a second optical path of the light beam between the second focusing plane and the splitting means and such that a first dispersion between the first focusing plane and the splitting means is substantially equal to a second dispersion of the light beam between the second focusing plane and the splitting means.

2. The device for tomographic imaging according to claim 1, wherein the interferometric imaging system also comprises at least one second medium positioned between the first focusing plane and the splitting means and in contact with the object to be analyzed, the at least one second medium having optical properties substantially equal to the optical properties of the object to be analyzed.

3. The device for tomographic imaging according to claim 2, wherein the interferometric imaging system also comprises at least a third medium with an optical index and thickness such that the first optical path is substantially equal to the second optical path and the first dispersion is substantially equal to the second dispersion.

4. The device for tomographic imaging according to claim 2, wherein the first medium possesses optical properties substantially equal to the optical properties of the object to be analyzed.

5. The device according to claim 2, wherein the object to be analyzed is essentially composed of water.

6. The device according to claim 1, also comprising at least a second medium positioned between the first focusing plane and the splitting means, at least one of the first and second media having a variable thickness.

7. The device according to claim 2, wherein the interferometric imaging system is a Mirau interferometer.

8. An interferometer for the tomographic imaging of a slice of an object to be analyzed, the interferometer comprising:
a means of fixing to an objective;
a reference mirror; and
a light beam splitting means,
wherein the interferometer is arranged so that the objective defines a first focusing plane at the slice of the object to be analyzed, and a second focusing plane at a surface of the reference mirror, and
wherein the interferometer comprises at least a first compensating medium positioned between the second focusing plane and the splitting means, the thickness and optical index of the compensating medium is such that a first optical path of a light beam between the first focusing plane and the splitting means is substantially equal to a second optical path of the light beam between the second focusing plane and the splitting means so that a first dispersion between the first focusing plane and the splitting means is substantially equal to a second dispersion of the light beam between the second focusing plane and the splitting means.

9. The interferometer according to claim 8, also comprising a second medium positioned between the first focusing plane and the splitting means and in contact with the object to be analyzed, the second medium having optical properties substantially equal to the optical properties of the object to be analyzed.

10. The interferometer according to claim 9, wherein the interferometric imaging system also comprises at least a third medium with an optical index and thickness such that the first optical path is substantially equal to the second optical path and the first dispersion is substantially equal to the second dispersion.

11. The interferometer according to claim 8, also comprising at least a second medium positioned between the first focusing plane and the separation means, at least one of the first and second media having a variable thickness.

12. The interferometer according to claim 8, wherein the fixing means allows an adjustment of a position of the interferometer with respect to the objective.

13. The interferometer according to claim 8, wherein the interferometer is fixed to an immersion objective via the fixing means.
The interferometer according to claim 8, wherein the interferometer is fixed to an objective comprising a means of correcting the aberrations introduced by various elements of the interferometer and by penetration into the object.

14. The interferometer according claims 8, wherein the interferometer is a Mirau interferometer.
